(19) United States
(12) Patent Application Publication
(10) Pub. No.: US 2013/0271579 A1
(43) Pub. Date: Oct. 17, 2013

(54) Mobile Stereo Device: Stereo Imaging, Measurement and 3D Scene Reconstruction with Mobile Devices such as Tablet Computers and Smart Phones

(71) Applicant: Younian Wang, Johns Creek, GA (US)

(72) Inventor: Younian Wang, Johns Creek, GA (US)

(21) Appl. No.: 13/447,175

(22) Filed: Apr. 14, 2012

(51) Int. Cl. H04N 13/02

(52) U.S. Cl. 348/47; 348/E13.074

(57) ABSTRACT

A mobile stereo imaging and processing device includes an ordinary mobile device such as tablet computers and smartphones; two or more digital cameras with stereo mounting requirements; a photography timing controller to operate the cameras, preferably with synchronized image capture capacity; a processor instruction package (software processing units) to control and operate the device, visualize and measure the images, compute and derive 3-dimentional object information from the captured 2-dimentional images; and some optional components such as remote control, GPS and IMU and optional processor instruction units for the control, operation and processing of the corresponding components.

### BACKGROUND

Many mobile devices such as tablet computers (e.g. Apple iPad and Samsung Galaxy Tab) and smartphones (e.g. Apple iPhone, Motorola Droid Razr Maxx, Samsung Galaxy Nexus) have a build-in digital camera for users to take a picture of his/her interest, and send and share it with other people. However none of these devices can provide users the feature to do stereo and 3D measurement with the images.

Stereo vision (or stereopsis) is a process for determining the 3-dimentional coordinates or distance of points in a scene from two or more images of the scene captured from different viewpoints in space. Stereo vision algorithms have been used in many computer based applications to model terrain and objects for vehicle navigation, surveying, and geometric inspection, for example.

The present invention is to give the mobile devices the 3D and stereo capability by installing 2 or more cameras and allowing them to take images simultaneously, and using methods and algorithms to do stereo measurement, stereo viewing and 3D scene reconstruction.

### BRIEF DESCRIPTION OF THE DRAWINGS

The appended drawings are to clarify and explain the aspects of the present invention. They depict only typical embodiments of the invention and are therefore not to be considered limiting of its scope.

FIG. 1 is a schematic representation of a mobile stereo imaging device in a typical configuration with two cameras.

FIG. 2 is a schematic representation of a mobile stereo imaging device in another configuration with four cameras.

FIG. 3 is a schematic representation of the principles of 3D coordinate computation from two overlapped 2D images in a preferable configuration of the cameras, with the corresponding equations described thereafter.

FIG. 4 is a schematic representation of the principles of 3D coordinate computation from two overlapped 2D images in a general configuration of the cameras, with the corresponding equations described thereafter.

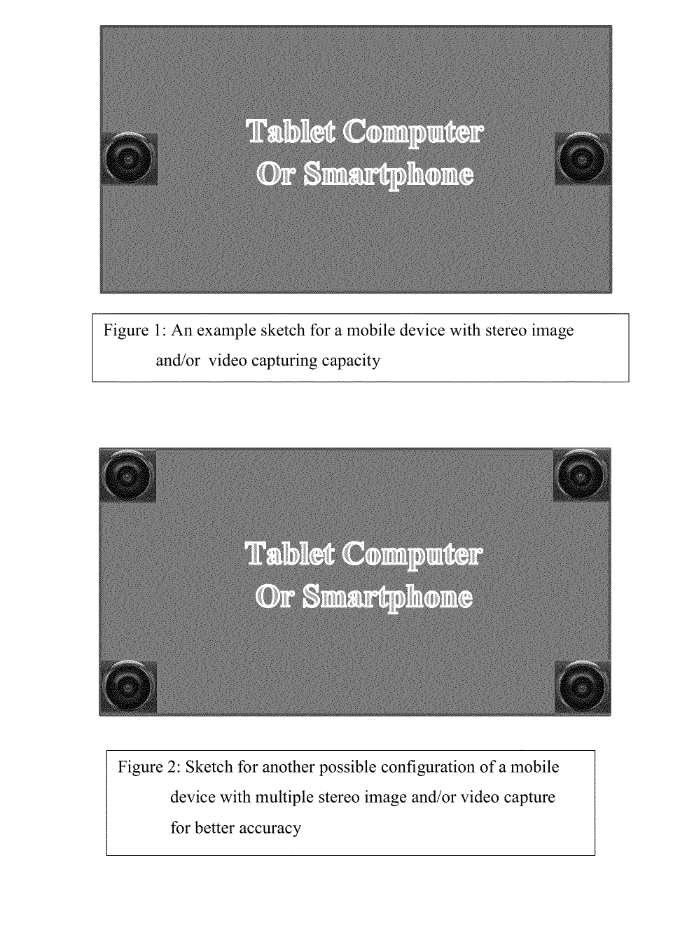

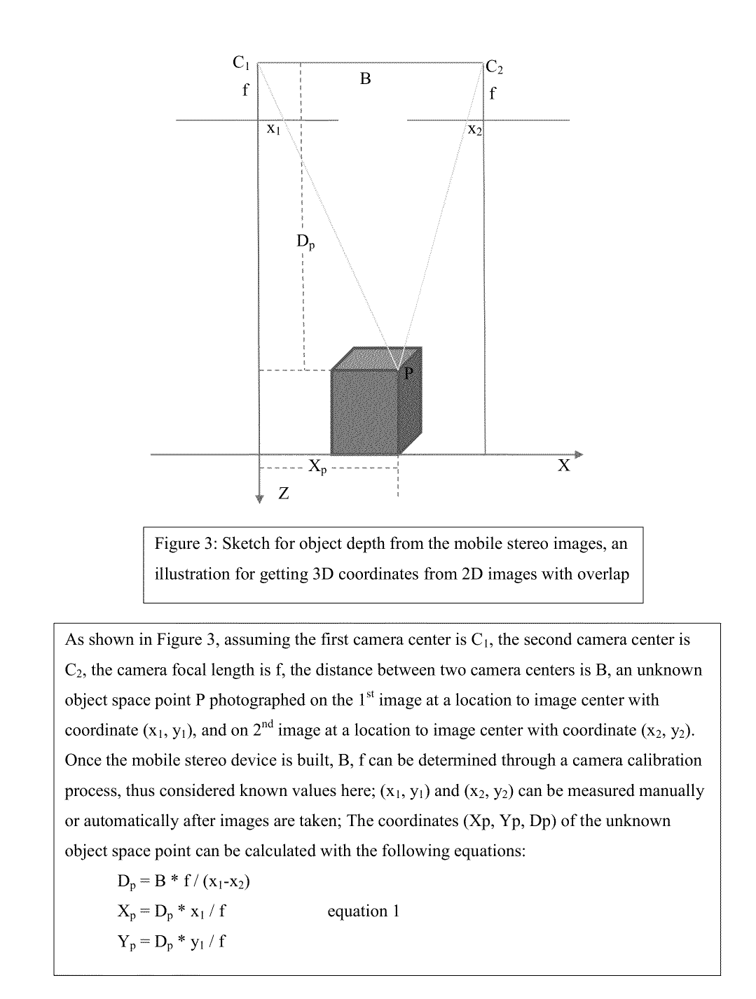

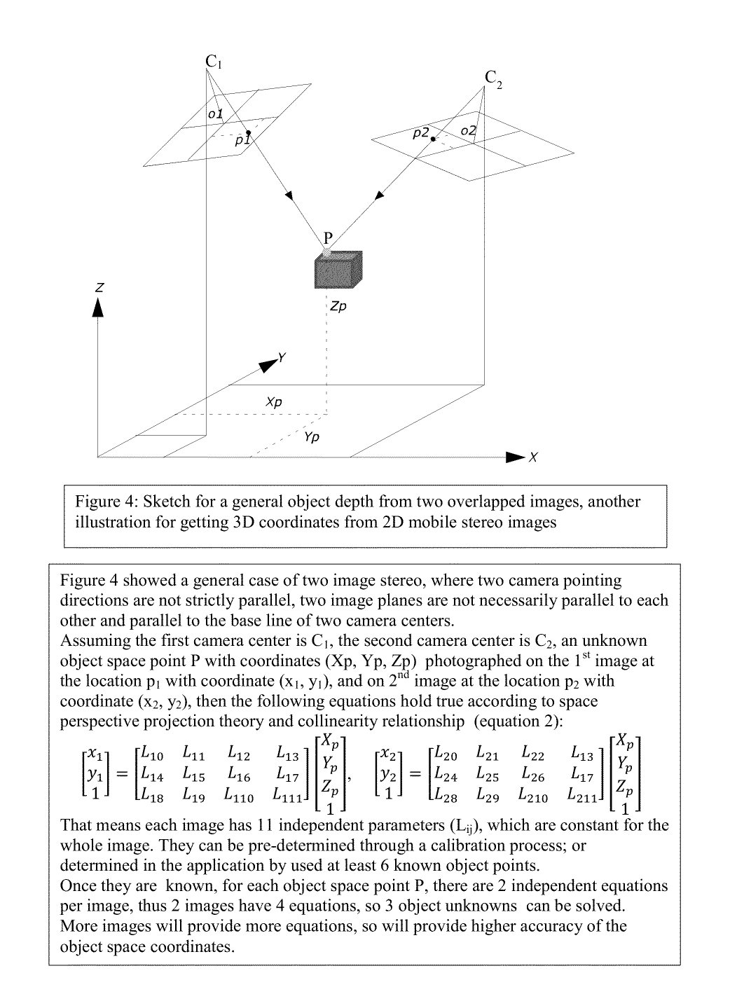

What is claimed is:

1. An mobile stereo imaging system comprising of:
a. An ordinary mobile device such as any tablet computer or smartphone, which has the typical components and features such as (but not limited to) a processor, RAM, operating system, display unit (screen), digital storage media, Wi-Fi or 3G/4G wireless connection;
b. Two or more digital cameras with or without video capture capacity;
c. A controller unit to control and operate the cameras, preferably a photography timing controller for synchronized image capture from two or more cameras. Synchronized image capture is the preferable choice since it can collect 3D information for moving objects. However a simplified controller without synchronization feature can also be used to operate the cameras taking images for still object for 3D information collection;
d. An optional remote control for operating the cameras and data processing and transfer remotely;
e. An optional position sensor, such as a GPS (global positioning system) device to record the position of the cameras;
f. An optional attitude sensor, such as an IMU (inertial measurement unit) to record the attitude of the cameras;
g. An optional level bubble to keep the device horizontal;
h. An optional wired connection, such as a USB connection, to transfer images and data between the mobile device and other devices such as desktop computers.
i. The other necessary connection cables, control units and other pieces for the above described components to make the device working correctly.

2. Camera mounting methods in the mobile stereo imaging system:
a. The cameras should be mounted or installed in the mobile device with certain distance to each other. Example locations can be the middle of each site of the device or the corners of the device. At least two cameras will be used. In case of just two cameras are used, these two cameras should not be mounted immediately next to each other. That means certain distance between cameras has to be maintained. The longer the distance is, the better the accuracy it can achieve. The pointing direction of the cameras can be parallel, or with some inclined angles. The mounting locations and number of cameras to use can be very flexible. The only requirement is that the image from one camera should have some overlap with the image from its adjacent camera, but two cameras cannot be installed at the same location.
b. A typical configuration is to use two cameras with the pointing direction parallel to each other, and perpendicular to the line going through the centers of two cameras. This typical case will make the processing of the acquired images much simpler and faster. It is also the ideal configuration for stereo and 3d video capture. It has to be pointed out that mounting two cameras at almost same location, but pointing to opposite directions (i.e. pointing direction almost 180 degrees, such as with Apple iPad2) does not meet the mounting requirements of this invention, thus is not included in this invention, because it is impossible for these two cameras to capture overlapped images simultaneously.

3. A processor instruction (software) package in the mobile stereo imaging system which controls and operate the mobile devices and cameras for taking images and video; viewing and processing the images and video in 2-dimentional or stereo mode; measuring the images manually or automatically, computing and extracting 3-dimentional object information from the photographed 2-dimentional images. The software package can be specified in, but not limited to the following modules (can have more or less modules depending on its usage and applications):
a. A processor instruction module (software) for camera intrinsic and extrinsic parameters calibration programmed from publically available algorithms and methods or specifically designed or developed algorithms and methods. The camera intrinsic parameters include focal length, location of principal point, camera lens distortion parameters etc. The extrinsic parameters include the position of the camera center and the attitude of the camera image plane.
b. A processor instruction module (software) for controlling the camera operations.
c. A processor instruction module (software) for image viewing and measurement. The viewing and measurement can be made in 2-dimentional viewer (images are displayed separately) or in a stereo viewer where two overlapped images are displayed stereoscopically.
d. A processor instruction module (software) for automatically matching or recognizing the same points or other features on all images which are corresponding to the same object point or feature. For example a house corner is photographed and shown up on two images, the purpose of this module is to automatically recognize the location of the house corner on both images and report their image coordinates. This procedure is commonly called image matching. There are several algorithms publically available for image matching such as Normalized Cross Correlation.
e. A processor instruction module (software) which computes the 3-dimentional coordinates of the object space points from the camera parameters and measured image point coordinates. It also includes the computation of derived variables such as length, height, size, area and volume of an object and the detailed 3-dimentioanl digital surface model and representation of the object surface with point clouds.
f. Other optional processor instruction modules to control, operate and process the optional components such as GPS and IMU.
g. Other optional processor instruction modules for visualization, analysis, transfer or sharing of the stereoscopic images and derived data and results.
